(19) United States
(12) Patent Application Publication
(10) Pub. No.: US 2010/0169514 A1
(43) Pub. Date: Jul. 1, 2010

(54) PICTURE PUSH

(75) Inventors: Kei Noguchi, San Jose, CA (US); Richard Pavlicek, JR., Santa Clara, CA (US); Adam Potolsky, Sunnyvale, CA (US)

Correspondence Address: Nixon Peabody LLP, P.O. Box 60610, Palo Alto, CA, 94306, US

(73) Assignee: IP Infusion Inc., a Delaware Corporation

(21) Appl. No.: 12/346,717

(22) Filed: Dec. 30, 2008

(51) Int. Cl. G06F 3/00

(52) U.S. Cl. 710/19

(57) ABSTRACT

A media providing device is configured to communicate with a media rendering device through a standard supported by the media providing device and the media rendering device. The media providing device comprises a first module configured to acquire new media on the media providing device and to store the new media on the media providing device. The media providing device also comprises a media server configured to automatically detect the new media, and a media controller configured to, responsive to the detecting, control the media rendering device to download the new media from the media providing device. The media rendering device comprises a screen and a media renderer configured to receive an instruction from the media providing device, instructing the media rendering device to retrieve media from the media providing device, request the media from the media providing device, receive the media, and render the media on the screen.

### RELATED APPLICATIONS

This application is related to the following commonly assigned U.S. patent application filed on even date herewith:

Ser. No. ______, entitled “Render Hopping” (Attorney Docket No. 434997-0026).

The related application is hereby incorporated herein by reference as if set forth fully herein.

### FIELD OF THE INVENTION

The present invention relates to the field of computer science. More particularly, the present invention relates to pushing pictures to electronic devices.

### BACKGROUND OF THE INVENTION

UPnP is a standard related to computer network protocols and that is supervised by the Digital Living Network alliance (DLNA). The goal of UPnP is to establish a wired and wireless interoperable network of personal computers, consumer electronics, and mobile devices in the home or office that enables a seamless environment for data communications.

FIG. 1 is a block diagram that illustrates interoperation between conventional electronic devices supporting the UPnP standard. A media rendering device 100 and a digital camera cell phone (hereafter referred to as a media providing device) 100 both support the UPnP standard, and are connected to a home network that is established based on the UPnP architecture. Through the connectivity offered by UPnP, each of the media providing device 105 and the media rendering device 100 is aware of the presence and capabilities of the other device, and is able to communicate with the other device. Manual user manipulation of the media providing device 105 and/or the media rendering device 100 is required to display the digital pictures stored in the media providing device 105 on the media rendering device 100.

Turning now to FIG. 2, the media providing device 305 includes a digital media server (DMS) 310 and a digital media controller (DMC) 320, and the media rendering device 330 includes a digital media renderer (DMR) 325 and a screen 335. The DMS 310 includes a content directory service (CDS) 300, and a streaming server 315 electrically coupled to the CDS 300. The CDS 300 exposes digital images stored in the media providing device 305 to the home network (not shown), and the streaming server 315 outputs the digital images stored in the media providing device 305 to the home network. The streaming server 315 supports the hypertext transfer protocol (HTTP).

The DMR 325 renders the digital images on the screen 335. The DMC 320 browses the digital images exposed by the CDS 300 of the DMS 310, searches for the DMR 325 in the home network having the capability of rendering the digital images exposed by the CDS 300, and establishes a peer-to-peer connection between the streaming server 315 and the DMR 325 to enable uploading of the digital images stored in the media providing device 305 to the DMR 325.

The process for displaying the digital images of the conventional media providing device 305 on the media rendering device 330 begins with the DMS 310 receiving and storing a playlist established by the user. The playlist includes a set of digital images selected by the user and waiting to be displayed. The CDS 300 of the DMS 310 exposes the data stored in the media providing device 305 to the home network.

Next, the DMC 320 receives an instruction from the user to select the playlist from the data stored by the DMS 310 and exposed by the CDS 300 of the DMS 310. The DMC 320 establishes a connection between the streaming server 315 of the DMS 310 and the DMR 325, and sets a uniform resource identifier (URI) of the DMR 325 as the streaming server 315 of the DMS 310.

Next, the DMC 320 controls the DMR 325 to initiate the process for displaying the digital images. The DMR 325 issues a request to the streaming server 315 of the DMS 310 through the HTTP protocol to download a digital image so that a digital image in the playlist is obtained from the DMS 310. The DMR 325 renders the digital image through the screen 335, after which downloading of a subsequent digital image begins.

One drawback of the conventional UPnP compatible media providing device 305 is that it is necessary for the user to manually select digital images waiting to be displayed to establish the playlist, and to again select the playlist from the data stored in the DMS 310. Hence, the user must perform a manual selection operation two times.

FIG. 2 is a block diagram that illustrates interoperation between conventional electronic devices supporting the UPnP standard. A media rendering device 200 and a media providing device such as an MP3 player 205 both support the UPnP standard, and are connected to a home network that is established based on the UPnP architecture. Through the connectivity offered by UPnP, each of the media providing device 205 and the media rendering device 200 is aware of the presence and capabilities of the other device, and is able to communicate with the other device. Manual user manipulation of the media providing device 205 and/or the media rendering device 200 is required to play the media stored in the media providing device 205 on the media rendering device 200. Furthermore, changing or “hopping” from playing media on media providing device 205 to playing the media on media rendering device 200 results in discontinuity in the user's listening or viewing experience.

Accordingly, a need exists in the art for an improved solution for pushing pictures to electronic devices. Additionally, need exists in the art for an improved solution for render hopping between electronic devices.

### SUMMARY OF THE INVENTION

A media providing device is configured to communicate with a media rendering device through a standard supported by the media providing device and the media rendering device. The media providing device comprises a first module configured to acquire new media on the media providing device and to store the new media on the media providing device. The media providing device also comprises a media server configured to automatically detect the new media, and a media controller configured to, responsive to the detecting, control the media rendering device to download the new media from the media providing device. The media rendering device comprises a screen and a media renderer configured to receive an instruction from the media providing device, instructing the media rendering device to retrieve media from the media providing device, request the media from the media providing device, receive the media, and render the media on the screen.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram that illustrates interoperation between conventional electronic devices supporting the UPnP standard.

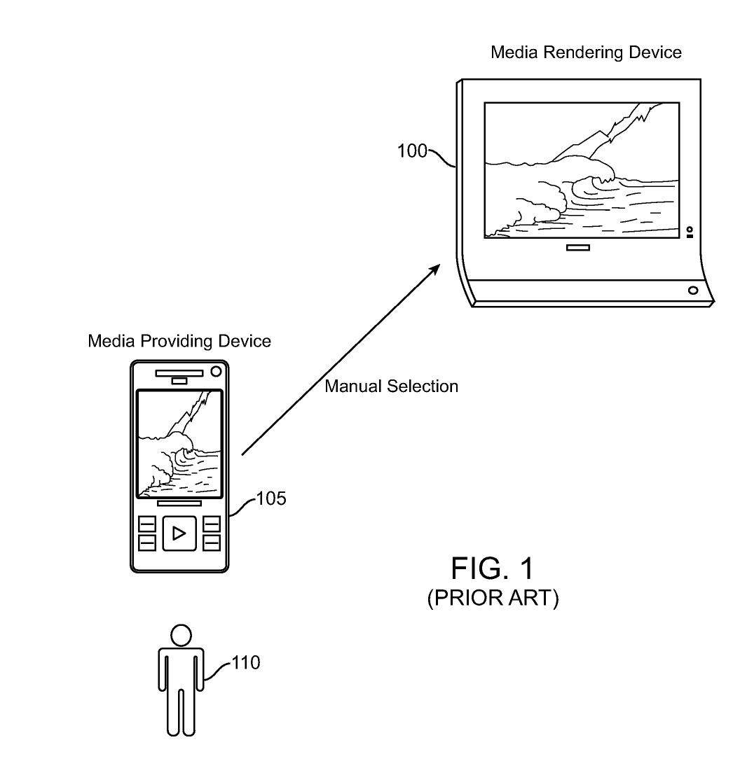

FIG. 2 is a block diagram that illustrates interoperation between conventional electronic devices supporting the UPnP standard.

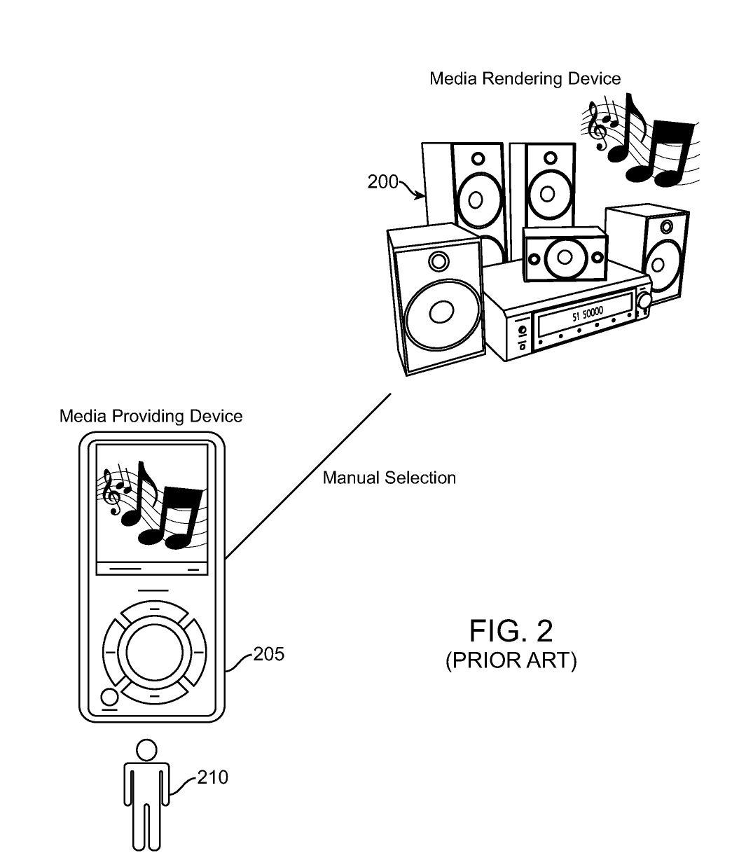

FIG. 3 is a block diagram that illustrates interoperation between conventional electronic devices supporting the UPnP standard.

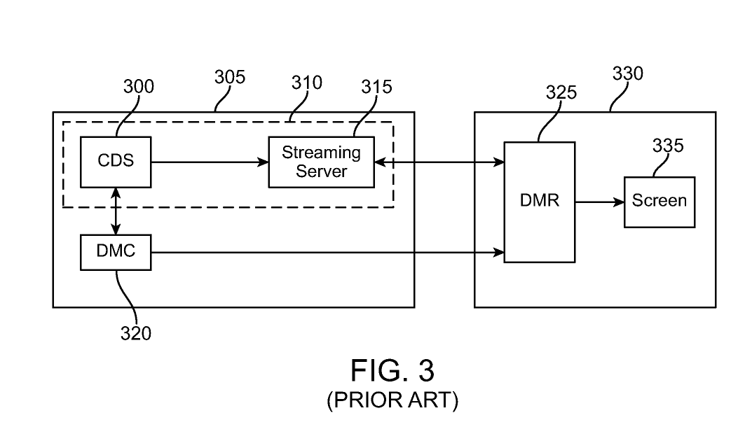

FIG. 4 is a block diagram that illustrates a system for pushing pictures between electronic devices in accordance with one embodiment of the present invention.

FIG. 5 is a flow diagram that illustrates a method for pushing pictures between electronic devices, from the perspective of a media providing device, in accordance with one embodiment of the present invention.

FIG. 6 is a flow diagram that illustrates a method for pushing pictures between electronic devices, from the perspective of a media rendering device, in accordance with one embodiment of the present invention.

FIG. 7 is a block diagram that illustrates a system for render hopping in accordance with one embodiment of the present invention.

FIG. 8 is a flow diagram that illustrates a method for render hopping, from the perspective of a media providing device, in accordance with one embodiment of the present invention.

FIG. 9 is a flow diagram that illustrates a method for controlling a new media renderer to render the media beginning at a current position, in accordance with one embodiment of the present invention.

FIG. 10 is a block diagram of a computer system suitable for implementing aspects of the present invention.

### DETAILED DESCRIPTION

Embodiments of the present invention are described herein in the context of a method and apparatus for pushing pictures to devices. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

According to one embodiment of the present invention, the components, process steps, structures, or any combination thereof, may be implemented using various types of operating systems (OS), computing platforms, firmware, computer programs, computer languages, general-purpose machines, or any combination thereof. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes data structures, or any combination thereof, may be implemented using machine language, assembler, C or C++, Java, other high level language programs running on computers (such as running windows XP, XP PRO, CE, 2000K (other windows), Linux or Unix, Solaris, Palm, or Apple OS X based systems), or any combination thereof According to one embodiment of the present invention, the processes may be implemented using a distributed component management and run-time deployment tool such as MOJO, by Object Forge, LTD of the United Kingdom. Different implementations may be used and may include other types of operating systems, computing platforms, computer programs, firmware, computer languages, general-purpose machines, or any combination thereof; and may also include various CCD cameras, color cameras, infrared cameras, analog cameras, digital cameras, video cameras, still picture cameras, mobile cameras, stationary cameras, and other types of sensor devices. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

According to one embodiment of the present invention, the method may be implemented on a data processing computer such as a personal computer, workstation computer, mainframe computer, or high performance server running an OS such as Solaris® available from Sun Microsystems, Inc. of Santa Clara, Calif., Microsoft® Windows® XP and Windows® 2000, available from Microsoft Corporation of Redmond, Wash., or various versions of the Unix operating system such as Linux available from a number of vendors. The method may also be implemented using mobile phones, such as those sold by Nokia and Ericsson, etc. The method may also be implemented on a mobile device running an OS such as Windows® CE, available from Microsoft Corporation of Redmond, Wash., Symbian OS™, available from Symbian Ltd of London, UK, Palm OS®, available from PalmSource, Inc. of Sunnyvale, Calif., and various embedded Linux operating systems. Embedded Linux operating systems are available from vendors including MontaVista Software, Inc. of Sunnyvale, Calif., and FSMLabs, Inc. of Socorro, N. Mex. The method may also be implemented on a multiple-processor system, or in a computing environment including various peripherals such as input devices, output devices, displays, digital cameras, mobile phones, digital video cameras, mobile computing devices, pointing devices, memories, storage devices, media interfaces for transferring data to and from the processor(s), and the like. In addition, such a computer system or computing environment may be networked locally, or over the Internet or other networks.

In the context of the present invention, the term “connection means” includes any means by which a first one or more devices communicate with a second one or more devices. In more detail, a connection means includes networks and direct connection mechanisms, parallel data busses, and serial data busses.

In the context of the present invention, the term “network” includes local area networks, wide area networks, metro area networks, residential networks, personal area networks, corporate networks, inter-networks, the Internet, the World Wide Web, ad-hoc networks, peer-to-peer networks, server networks, backbone networks, cable television systems, telephone systems, wireless telecommunications systems, WiFi networks, Bluetooth networks, SMS networks, MMS networks, fiber optic networks, token ring networks, Ethernet networks, ATM networks, frame relay networks, satellite communications systems, and the like. Such networks are well known in the art and consequently are not further described here.

In the context of the present invention, the term “identifier” describes an ordered series of one or more numbers, characters, symbols, or the like. More generally, an “identifier” describes any entity that can be represented by one or more bits.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present invention, the term “data stores” describes a hardware means or apparatus, a software means or apparatus, or a hardware and software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, RAID storage, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, multidimensional databases, SQL databases, audit trails and logs, program memory, cache and buffers, and the like.

In the context of the present invention, the term “user interface” describes any device or group of devices for presenting information to or from persons or animals, receiving information to or from persons or animals, or both. A user interface may comprise a means to present information to persons or animals, such as a visual display projector or screen, a loudspeaker, a light or system of lights, a printer, a Braille device, a vibrating device, or the like. A user interface may also include a means to receive information or directions from persons or animals, such as one or more or combinations of buttons, keys, levers, switches, knobs, touch pads, touch screens, microphones, speech detectors, motion detectors, cameras, and light detectors. Exemplary user interfaces comprise pagers, mobile phones, desktop computers, laptop computers, handheld and palm computers, personal digital assistants (PDAs), cathode-ray tubes (CRTs), keyboards, keypads, liquid crystal displays (LCDs), control panels, horns, sirens, alarms, printers, speakers, mouse devices, consoles, and speech recognition devices.

In the context of the present invention, the term “system” describes any computer information device, computer control device, device or network of devices, comprising hardware, software, or both, which comprise a processor means, data storage means, program means, user interface means, or combination thereof, and which is adapted to communicate with the embodiments of the present invention, via one or more data networks or connections, and is adapted for use in conjunction with the embodiments of the present invention.

In the context of the present invention, the term “picture” describes any digital visual media such as photographs, still photographs, images, moving pictures, video, films, shorts, edited or manipulated photographs, edited or manipulated video, drawings, paintings, slide decks, line drawings, sketches, computer generated images, animated films, commercial films, television shows, commercials, home video, security video, security photographs, monitor video, monitor photographs, satellite images, aerial images, underwater images, space images, medical images, video art, graphics, art graphics, animal art, machine art, nature generated art, composites of any of the above, or hybrids of any of the above. Such pictures may be encoded in various forms or standards known now or in the future, such as jpeg, bmp, tiff, mpeg, wmv, etc. Such pictures may also be singular or in collections, including composite or hybrid mixes, structured or unstructured. Pictures may be the product of accident, intent, design, natural, mechanical, or computing process. Pictures also may be constructed, recorded, live, streaming, etc. Pictures may include associated other information, data, meta-data, XML, RDF, text, symbols, sound, music, etc.

In the context of the present invention, the term “message” describes an ordered series of one or more bits, numbers, characters, symbols, or the like, intended to transfer or carry information between one or more entities or systems. Examples include one or more of SMS messages, MMS messages, telecommunications messages, information packets, information transmissions, coded communications, etc. A message may contain all or any part, in any coding, of text, symbols, graphics, language, instructions, codes, numbers, patterns, pictures, data, meta-data, identifiers, time stamps, counters, names, addresses, etc.

In the context of the present invention, the connections, networks, or both, of the system, servers, client devices, their components, and third party systems, may be one or more connections, networks, shared, or unshared in any configurations among the components. Thus also in the context of the present invention, the components, hardware, software, or both, may be physically and/or logically co-located or distributed or incorporated among each other or incorporated in other systems in any configuration.

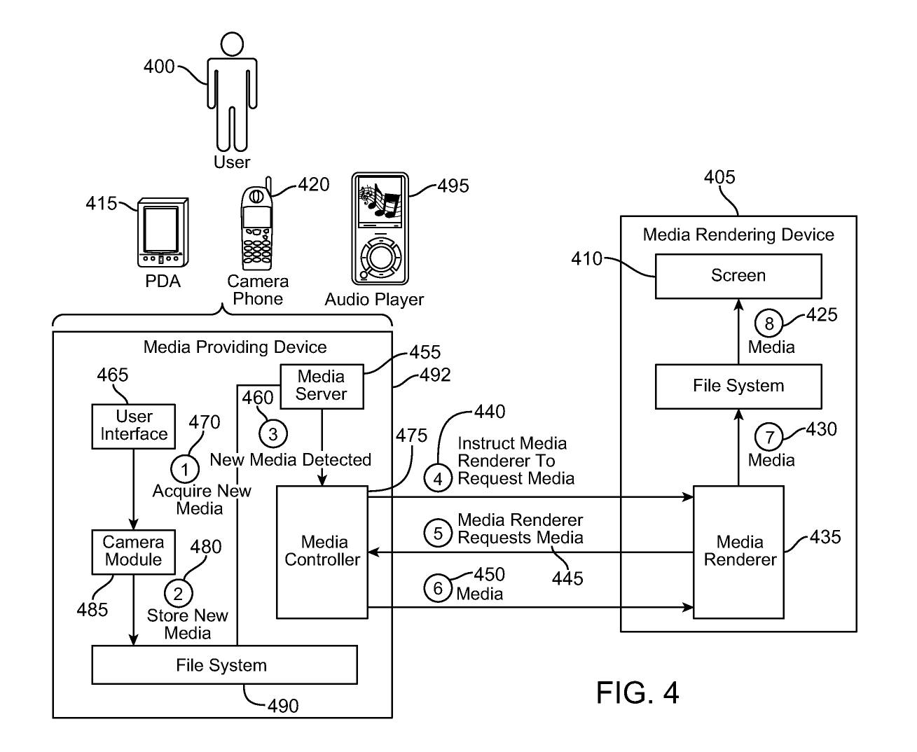

FIG. 4 is a block diagram that illustrates a system for pushing pictures between electronic devices in accordance with one embodiment of the present invention. As shown in FIG. 4, a media providing device 492 is configured to communicate with a media rendering device 405 through a standard supported by the media providing device 492 and the media rendering device 405. The media providing device 492 comprises a first module 485 configured to acquire new media on the media providing device 492, and to store the new media on the media providing device 492. For example, the first module 485 may be a camera module configured to store in file system 490, pictures taken by a user 400 using the media providing device 392.

The media providing device 492 also comprises a media server 455 configured to automatically detect the new media stored on the media providing device 492, and a media controller 475 configured to, responsive to the detecting, control the media rendering device 405 to download the new media from the media providing device 492.

According to one embodiment of the present invention, the media controller 475 is further configured to, responsive to the detecting, instruct the media rendering device 405 to retrieve the media from the media providing device 492, receive from the media rendering device 405, a request for the media, and send the media to the media rendering device 405.

According to one embodiment of the present invention, the new media comprises one or more digital images. According to another embodiment of the present invention, the new media comprises one or more digital videos.

According to one embodiment of the present invention, the standard supported by the media rendering device 405 and said media providing device 492 is the Universal Plug and Play (UPnP) standard supervised by the Digital Living Network Alliance (DLNA). The media server 455 may be further configured to examinine a SystemUpdateID variable, specified by the UpnP standard, to detect the new media stored on the media providing device. Alternatively, the media server 455 may be further configured to examinine a ContainerUpdateIDs state variable to detect the new media stored on the media providing device.

According to one embodiment of the present invention, the media providing device 492 is further configured to, before acquiring the new media, receive an indication of where on the media providing device new media is to be stored.

According to one embodiment of the present invention, the new media comprises a plurality of digital images, and the media controller 475 is further configured to control the media rendering device 405 to cycle through rendering each of the plurality of digital images.

According to one embodiment of the present invention, the media providing device comprises a camera phone, and the media rendering device comprises a television.

Still referring to FIG. 4, media rendering device 405 is configured to communicate with a media providing device 492 through a standard supported by the media providing device 492 and the media rendering device 405. The media rendering device comprises a screen 410 and a media renderer 435. The media renderer 435 is configured to receive an instruction from the media providing device 492, instructing the media rendering device 405 to retrieve media from the media providing device 492. The media renderer 435 is further configured to request the media from the media providing device 492, receive the media, and render the media on the screen 410.

According to one embodiment of the present invention, the new media comprises a plurality of digital images, and the media renderer 435 is further configured to cycle through rendering each of the plurality of digital images.

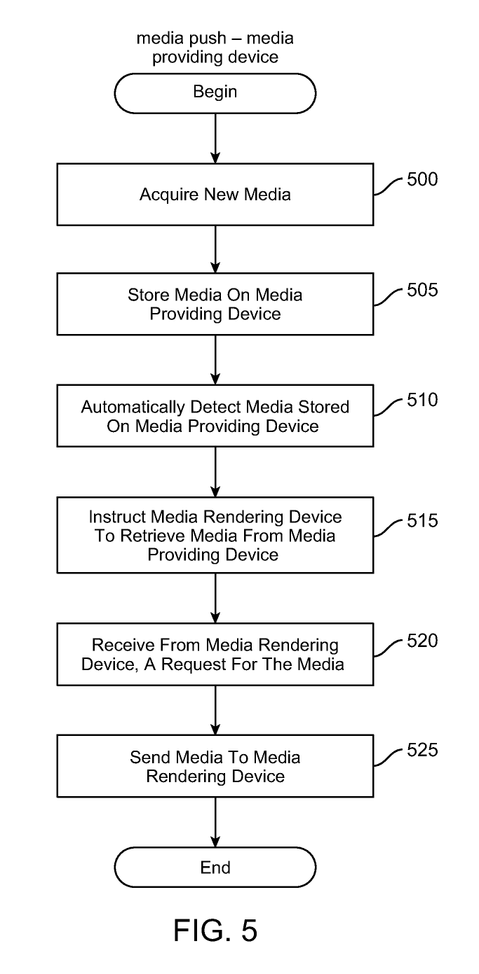

FIG. 5 is a flow diagram that illustrates a method for pushing pictures between electronic devices, from the perspective of a media providing device (reference numeral 492 of FIG. 4), in accordance with one embodiment of the present invention. The processes illustrated in FIG. 5 may be implemented in hardware, software, firmware, or a combination thereof. At 500, a media providing device acquires new media. At 505, the new media is stored on the media providing device. At 510, the presence of the new media stored on the media providing device is automatically detected.

At 515 through 525, responsive to the detecting, the media providing device controls the media rendering device to download the new media from the media providing device. At 515, responsive to the detecting, the media providing device instructs the media rendering device to retrieve the media from the media providing device. At 520, the media providing device receives from the media rendering device, a request for the media. At 525, the media providing device sends the media to the media rendering device.

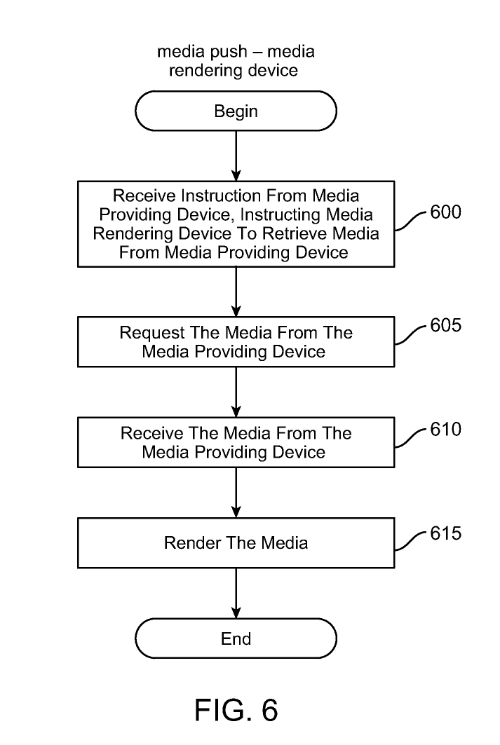

FIG. 6 is a flow diagram that illustrates a method for pushing pictures between electronic devices, from the perspective of a media rendering device (reference numeral 405 of FIG. 4), in accordance with one embodiment of the present invention. The processes illustrated in FIG. 6 may be implemented in hardware, software, firmware, or a combination thereof. At 600, an instruction from a media providing device is received. The instruction instructs the media rendering device to retrieve media from the media providing device. At 605, the media rendering device requests the media from the media providing device. At 615, the media rendering device receives the media. At 615, the media rendering device renders the media on the media rendering device.

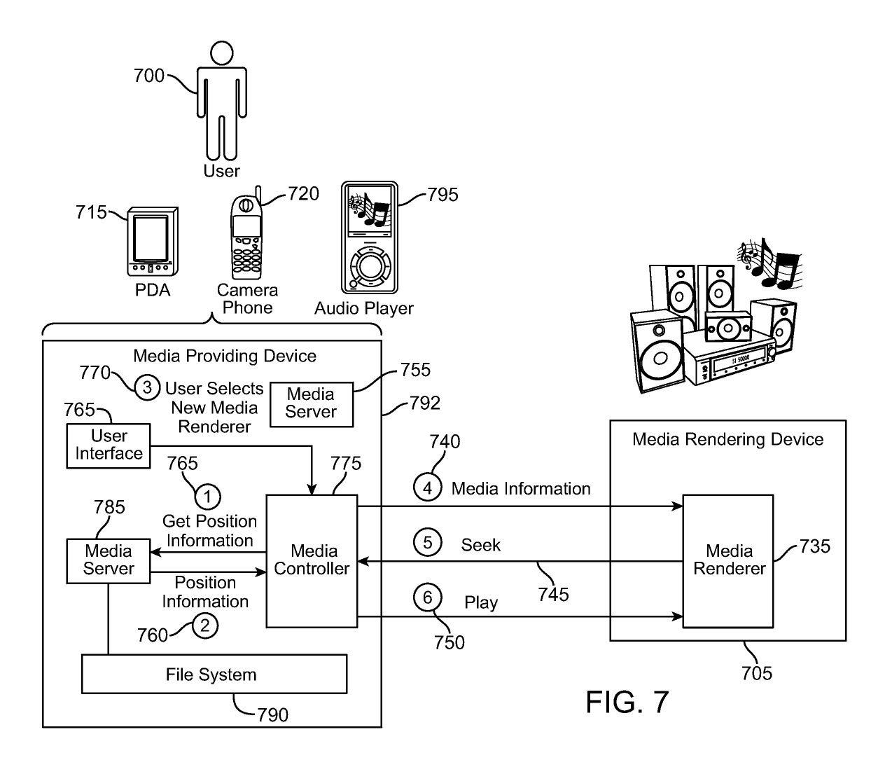

FIG. 7 is a block diagram that illustrates a system for render hopping in accordance with one embodiment of the present invention. As shown in FIG. 7, a media providing device having a current media renderer 755 is configured to communicate with a media rendering device 705 through a standard supported by the media providing device 792 and the media rendering device 705. The media providing device 792 comprises a file system 790 for storing media, and a media controller 775. The media controller 775 is configured to obtain current media position information from a media server 785 of the media providing device 792. For example, the current position information may comprise a track number, and a time value relative to the beginning of the track. The media controller 775 is configured to determine whether a user indicated a new media renderer. The media controller 775 is further configured to, if the user indicated a new media renderer 735, control the new media renderer 735 to render the media beginning at the current position, thereby providing a continuous rendition of the media while transitioning between media renderer 755 and media renderer 735.

According example embodiments of the present invention, the media controller 775 is further configured to select one of possibly multiple media renderers, such as media renderer 735.

According to one embodiment, media controller 775 is configured to select a default media renderer. The selection of the default media renderer may be overridden by the user 700.

According to another embodiment of the present invention, user interface 765 is configured to display a list of available media renderers. The user may select one of the available media renderers as the new media renderer 735.

According to another embodiment of the present invention, media controller 775 is configured to select a new media renderer 735 automatically based at least in part on one or more criteria. The one or more criteria may include, by way of example, a position of a user 700. For example, if three televisions are available as media rendering devices, media controller 775 may automatically select the television that is nearest the user 700. Media controller 775 may also base the selection at least in part on whether the user 700 is in a line of sight of a media rendering device 705 or within hearing distance of the media rendering device 705. For example, if three televisions are available as media rendering devices and the television that is closest to the user is in another room, media controller 775 may automatically select the nearest television in the same room as the user 700.

The one or more criteria may also include, by way of example, a kind of media. By way of example, if the kind of media is digital audio and both a clock radio and a home stereo are available media rendering devices, media controller 775 may automatically select the media renderer 735 associated with the home stereo.

The one or more criteria may also include, by way of example, a current state of the media renderer. By way of example, if the kind of media is digital video and the only available media renderer is a television that is currently in use, media controller 775 may automatically prompt the user regarding whether the media renderer 735 associated with the television should be selected.

According to one embodiment of the present invention, the media controller 775 is further configured to control the new media renderer 735 to render the media beginning at the current position by sending the current position information to the new media renderer 735, sending a seek command to the new media renderer 735, and sending a play command to the new media renderer 735.

According to one embodiment of the present invention, the media comprises one or more digital images. According to another embodiment of the present invention, the media comprises one or more digital videos. According to another embodiment of the present invention, the media comprises digital audio.

According to one embodiment of the present invention, the standard supported by the media rendering device 705 and said media providing device 792 is the Universal Plug and Play (UPnP) standard supervised by the Digital Living Network Alliance (DLNA). The media controller 775 may be further configured to obtain the current media position information by invoking a GetPositionInfo action to obtain the current media position information. The media controller 775 may be further configured to send the current position information to the new media renderer 735 using a SetAVTransportURI command.

According to one embodiment of the present invention, the media controller 775 is further configured to, after the controlling, continue to obtain current media position information from a media server 755 of the media providing device 792.

According to one embodiment of the present invention, the media providing device comprises a digital audio player and the media rendering device comprises a home stereo.

According to one embodiment of the present invention, the media controller 775 is further configured to, before determining whether a user 700 indicated a new media renderer 735, determine the presence of a new media renderer 735, and prompt the user 700 regarding selection of the new media renderer 735.

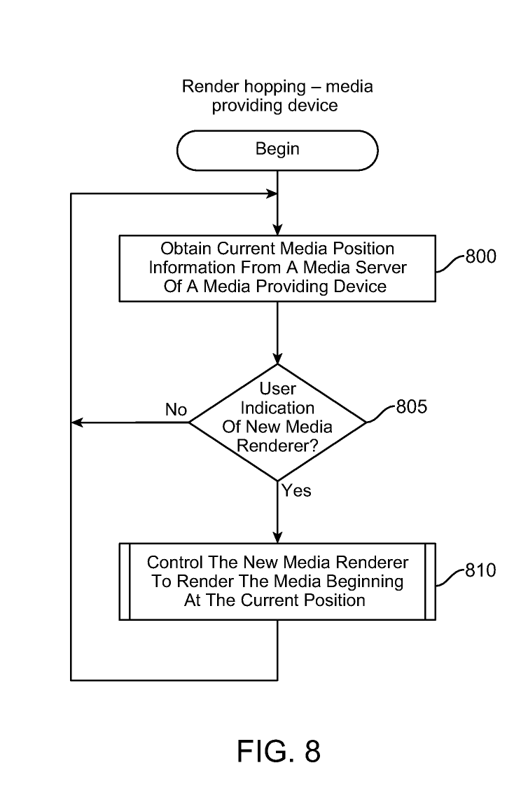

FIG. 8 is a flow diagram that illustrates a method for render hopping, from the perspective of a media providing device, in accordance with one embodiment of the present invention. The processes illustrated in FIG. 8 may be implemented in hardware, software, firmware, or a combination thereof. At 800, current media position information is obtained from a media server of the media providing device, where the media providing device has a current media renderer. At 805, a determination is made regarding whether a user indicated a new media renderer. At 810, if the user indicated a new media renderer, a media controller of the media providing device controls the new media renderer to render the media beginning at the current position.

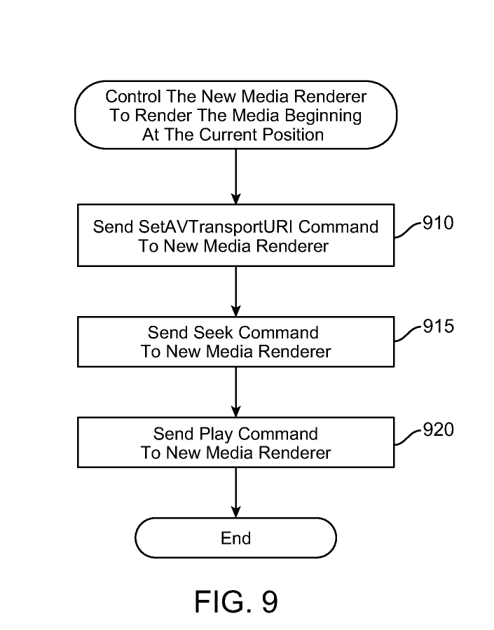

FIG. 9 is a flow diagram that illustrates a method for controlling a new media renderer to render the media beginning at a current position, in accordance with one embodiment of the present invention. The processes illustrated in FIG. 9 may be implemented in hardware, software, firmware, or a combination thereof. FIG. 9 provides more detail for reference numeral 810 of FIG. 8. A media controller of the media providing device controls the new media renderer to render the media beginning at the current position by sending the current position information to the new media renderer (910), sending a seek command to the new media renderer (915), and sending a play command to the new media renderer (920).

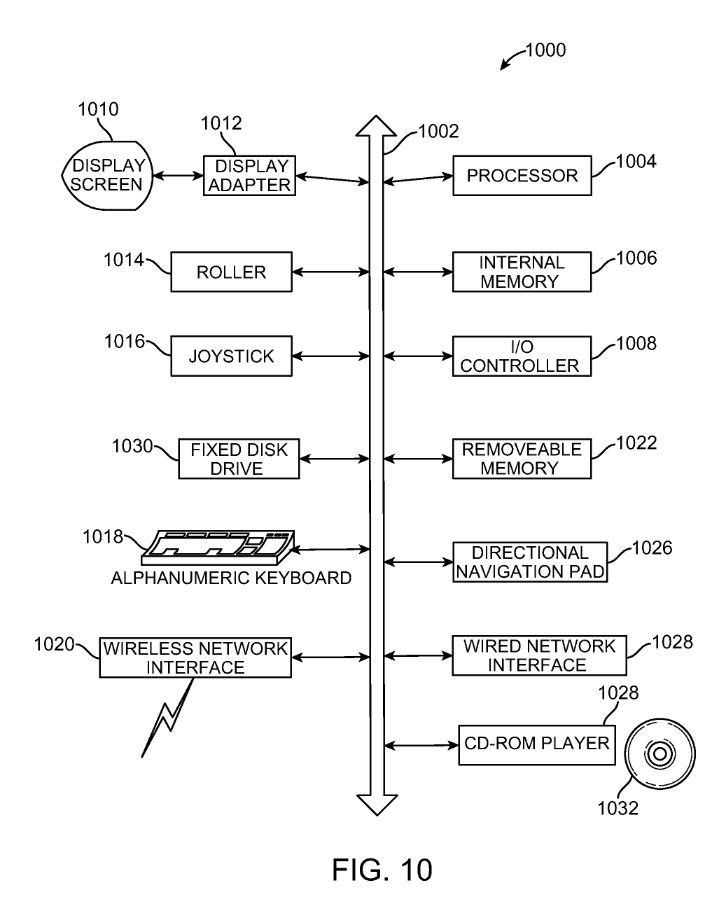

FIG. 10 depicts a block diagram of a computer system 1000 suitable for implementing aspects of the present invention. As shown in FIG. 10, computer system 1000 comprises a bus 1002 which interconnects major subsystems such as a central processor 1004, a system memory 1006 (typically RAM), an input/output (I/O) controller 1008, an external device such as a display screen 1010 via display adapter 1012, a roller 1014, a joystick 1016, a keyboard 1018, a fixed disk drive 1030, and a CD-ROM player 1026 operative to receive a CD-ROM 1032. Many other devices can be connected, such as a wireless network interface 1032. Wireless network interface 1020 may provide a direct connection to a remote server via a wireless link or to the Internet via a POP (point of presence). Alternatively, a network interface adapter 1028 may be used to interface to a local or wide area network using any network interface system known to those skilled in the art (e.g., Ethernet, xDSL, AppleTalk™).

Many other devices or subsystems (not shown) may be connected in a similar manner. Also, it is not necessary for all of the devices shown in FIG. 10 to be present to practice the present invention, as discussed below. Furthermore, the devices and subsystems may be interconnected in different ways from that shown in FIG. 10. The operation of a computer system such as that shown in FIG. 10 is readily known in the art and is not discussed in detail in this application, so as not to overcomplicate the present discussion. Code to implement the present invention may be operably disposed in system memory 1006 or stored on storage media such as fixed disk 1020 or CD-ROM 1032.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method to be implemented by a media providing device, the media providing device communicating with a media rendering device through a standard supported by the media providing device and the media rendering device, the method comprising:
acquiring new media on the media providing device;
storing the new media on the media providing device;
automatically detecting the new media stored on the media providing device; and
responsive to the detecting, controlling the media rendering device to download the new media from the media providing device.

2. The method of claim 1 wherein the controlling comprises:
responsive to the detecting, instructing the media rendering device to retrieve the media from the media providing device;
receiving from the media rendering device, a request for the media; and
sending the media to the media rendering device.

3. The method of claim 1 wherein the new media comprises one or more digital images.

4. The method of claim 1 wherein the new media comprises one or more digital videos.

5. The method of claim 1 wherein the standard supported by the media rendering device and said media providing device is the Universal Plug and Play (UPnP) standard supervised by the Digital Living Network Alliance (DLNA).

6. The method of claim 5 wherein the detecting comprises examining a SystemUpdateID variable to detect the new media stored on the media providing device.

7. The method of claim 5 wherein the detecting comprises examining a ContainerUpdateIDs state variable to detect the new media stored on the media providing device.

8. The method of claim 1, further comprising:
before the acquiring, receiving an indication of where on the media providing device new media is to be stored.

9. The method of claim 1 wherein
the new media comprises a plurality of digital images; and
the controlling further comprises controlling the media rendering device to cycle through rendering each of the plurality of digital images.

10. The method of claim 1 wherein
the media providing device comprises a camera phone; and
the media rendering device comprises a television.

11. A method to be implemented by a media rendering device, a media providing device communicating with the media rendering device through a standard supported by the media providing device and the media rendering device, the method comprising:
receiving an instruction from the media providing device, instructing the media rendering device to retrieve media from the media providing device;
requesting the media from the media providing device;
receiving the media; and
rendering the media on the media rendering device.

12. The method of claim 11 wherein the new media comprises one or more digital images.

13. The method of claim 11 wherein the new media comprises one or more digital videos.

14. The method of claim 11 wherein the standard supported by the media rendering device and said media providing device is the Universal Plug and Play (UPnP) standard supervised by the Digital Living Network Alliance (DLNA).

15. The method of claim 11 wherein
the new media comprises a plurality of digital images; and
the rendering further comprises cycling through rendering each of the plurality of digital images.

16. The method of claim 11 wherein
the media providing device comprises a camera phone; and
the media rendering device comprises a television.

17. A media providing device configured to communicate with a media rendering device through a standard supported by the media providing device and the media rendering device, the media providing device comprising:
a first module configured to:
acquire new media on the media providing device; and
store the new media on the media providing device;
a media server configured to automatically detect the new media stored on the media providing device; and
a media controller configured to, responsive to the detecting, control the media rendering device to download the new media from the media providing device.

18. The media providing device of claim 17 wherein the media controller is further configured to:
responsive to the detecting, instruct the media rendering device to retrieve the media from the media providing device;
receive from the media rendering device, a request for the media; and
send the media to the media rendering device.

19. The media providing device of claim 17 wherein the new media comprises one or more digital images.

20. The media providing device of claim 17 wherein the new media comprises one or more digital videos.

21. The media providing device of claim 17 wherein the standard supported by the media rendering device and said media providing device is the Universal Plug and Play (UPnP) standard supervised by the Digital Living Network Alliance (DLNA).

22. The media providing device of claim 21 wherein the media server is further configured to examinine a SystemUpdateID variable to detect the new media stored on the media providing device.

23. The media providing device of claim 21 wherein the media server is further configured to examinine a ContainerUpdateIDs state variable to detect the new media stored on the media providing device.

24. The media providing device of claim 17 wherein the device is further configured to, before acquiring the new media, receive an indication of where on the media providing device new media is to be stored.

25. The media providing device of claim 17 wherein
the new media comprises a plurality of digital images; and
the media controller is further configured to control the media rendering device to cycle through rendering each of the plurality of digital images.

26. The media providing device of claim 17 wherein
the media providing device comprises a camera phone; and
the media rendering device comprises a television.

27. A media rendering device configured to communicate with a media providing device through a standard supported by the media providing device and the media rendering device, the media rendering device comprising:
a screen; and
a media renderer configured to:
receive an instruction from the media providing device, instructing the media rendering device to retrieve media from the media providing device;
request the media from the media providing device;
receive the media; and
render the media on the screen.

28. The media rendering device of claim 27 wherein the new media comprises one or more digital images.

29. The media rendering device of claim 27 wherein the new media comprises one or more digital videos.

30. The media rendering device of claim 27 wherein the standard supported by the media rendering device and the media providing device is the Universal Plug and Play (UPnP) standard supervised by the Digital Living Network Alliance (DLNA).

31. The media rendering device of claim 27 wherein
the new media comprises a plurality of digital images; and
the media renderer is further configured to cycle through rendering each of the plurality of digital images.

32. The media rendering device of claim 27 wherein
the media providing device comprises a camera phone; and
the media rendering device comprises a television.

33. A media providing device configured to communicate with a media rendering device through a standard supported by the media providing device and the media rendering device, the media providing device comprising:
means for acquiring new media on the media providing device;
means for storing the new media on the media providing device;
means for automatically detecting the new media stored on the media providing device; and
means for responsive to the detecting, controlling the media rendering device to download the new media from the media providing device.

34. A media rendering device configured to communicate with a media providing device through a standard supported by the media providing device and the media rendering device, the media rendering device comprising:
means for receiving an instruction from the media providing device, instructing the media rendering device to retrieve media from the media providing device;
means for requesting the media from the media providing device;
means for receiving the media; and
means for rendering the media on the media rendering device.

35. A program storage device readable by a machine, embodying a program of instructions executable by the machine to perform a method to be implemented by a media providing device, the media providing device communicating with a media rendering device through a standard supported by the media providing device and the media rendering device, the method comprising:
acquiring new media on the media providing device;
storing the new media on the media providing device;
automatically detecting the new media stored on the media providing device; and
responsive to the detecting, controlling the media rendering device to download the new media from the media providing device.

36. A program storage device readable by a machine, embodying a program of instructions executable by the machine to perform a method to be implemented by a media rendering device, a media providing device communicating with the media rendering device through a standard supported by the media providing device and the media rendering device, the method comprising:
receiving an instruction from the media providing device, instructing the media rendering device to retrieve media from the media providing device;
requesting the media from the media providing device;
receiving the media; and
rendering the media on the media rendering device.
